(19) United States
(12) Patent Application Publication
(10) Pub. No.: US 2009/0148821 A1
(43) Pub. Date: Jun. 11, 2009

(54) SYSTEM AND METHOD FOR REMOTE VERIFICATION OF TRAINING

(76) Inventors: STEVE CARKNER, Ottawa (CA); Sol Avisar, Ottawa (CA)

Correspondence Address: J. GORDON THOMSON, P.O. BOX 8865, VICTORIA, BC, V8V 3Z1, CA

(21) Appl. No.: 12/274,739

(22) Filed: Nov. 20, 2008

Related U.S. Application Data
(60) Provisional application No. 60/989,836, filed on Nov. 22, 2007.

(51) Int. Cl. G09B 5/00; G09B 23/28

(52) U.S. Cl. 434/265; 434/362; 434/350; 434/335

(57) ABSTRACT

A system is provided for the validation of training by a validation authority of trainees located at remote locations. The training is delivered to the trainees electronically by the validation authority, generally, over the Internet. The training generally includes a theoretical component and a practicum. The practicum comprises the application of forces by the trainees on a mannequin such as in the case of CPR training or therapeutic massage training. The theoretical component of the training session is completed by the trainees on-line and the trainees are examined on-line. Examination results are transmitted to the verification authority. During the practicum examination, a mannequin is provided that is instrumented to measure forces applied by the trainees creating a dataset. The dataset is transmitted to the verification authority for comparison with therapeutically correct values. The verification authority will generate a pass or fail signal. If a pass signal is generated, a certification authority will issue a certificate of successful completion to the trainee by mail or by e-mail to the trainee's computer workstation. The system can include oversight by a training professional by two-way audio-visual communications between the verification authority location and the remote trainee location.

### CROSS-REFERENCE TO RELATED APPLICATIONS

This application is entitled to the benefit of Provisional Patent Application #60/989,836 filed on Nov. 22, 2007.

### BACKGROUND OF THE INVENTION

1. Field of the Invention

This invention relates to systems and methods used to transmit data and more particularly to a system and method for remote verification of training wherein such training includes the application of physical forces by a human on another human or upon an animal.

2. Background Discussion

A significant number of training programs have been created to address the need for people to learn how to do specific physical tasks where the application of such tasks is highly reliant on physical dexterity and application of physical force by hand to an object such as a human or an animal. Such applications of physical forces have been measured and criteria exists as to what is an appropriate amount of physical force to apply to successful perform a task.

For example, in an external heart massage, hand forces are applied to the sternum of a human in order to compress the heart muscle and generate diastolic blood pressure. Successful external heart massage is one activity that requires the application of correct pressures and forces to the human body to successfully reanimate a stopped heart. Victims to whom heart massage has been administered by hand sometimes receive injuries because of poor technique including improper placement of hands, improper application of pressure, distribution of pressure over too large an area, insufficient chest compression or too much chest compression.

The amount or extent of chest compression varies depending on the size and age of the victim. Thus, for most adults, the recommended chest compression is about 1.5 to 2 inches; for a child, ¾″ to 1.5″; and, for an infant ½″ to ¾″. The repetition rate of chest compression also varies, depending on size, age, and whether there are one or two rescuers involved in the procedure. Where a single rescuer is involved with an adult victim, the recommended repetition rate is 80 compressions per minute. If two rescuers are present, the rate drops to 60 per minute. For a child, 80-100 compressions per minute are recommended, while for an infant 100 compressions per minute are recommended. Obviously, even where two rescuers are present, given the trauma and anxiety present in the circumstances, it is most difficult for a rescuer to apply the requisite amount of pressure to achieve adequate chest compression and count the number of compressions per minute.

In the administration of heart massage, it is important that, once started, there be no more than a five second interruption in the procedure. It is also important that the application of pressure be rhythmic and regular, and that either mouth-to-mouth breathing accompanies the heart massage, or that some form of artificial respiration be provided.

Fluid pressures, depths of compression, compression rates and delays can be measured by sensors and verified as either within or outside of therapeutically acceptable tolerances. In a training situation, the proper application of an external heart massage can then be determined by measuring these parameters and assessing them against acceptable tolerances.

Another example is body massage which is used in a number of medical therapies and relies upon the proper amount of pressure applied by the hand to the target area on the body. Too much force will cause pain or damage and too little force will be therapeutically ineffective.

There exist dolls and “dummies” that are used to train practitioners of massage therapy and CPR. These help the trainee assume the correct position over the patient and apply the correct magnitude of forces to the correct location on the patient's body. These aids are most often used with a trainer in a classroom environment. However, there are situations, such as remote locations comprising construction sites or mines where classroom training and the availability of professional trainers is not practical. Therefore, there is a need to be able to continue to train individuals in such activities as CPR remotely and to provide a system whereby such remote training can take place and be verified by a remote authority as meeting standards for the awarding of a qualification. To the best of our knowledge, no such system exists.

### SUMMARY OF THE INVENTION

To resolve the deficiency noted above, the present invention provides a system and method that permits remote training in techniques requiring the manual application of force to a human body and the remote verification of such training leading to certification by a relevant authority.

In one embodiment of the invention there is provided a first remote training location. The first remote training location comprises at least one trainee undergoing an at least one training course, such as, and by way of a single illustrative example only, a training course for cardiopulmonary resuscitation (CPR). The successful completion of the training course requires, in whole or in part, the successful application of manual forces to an object that can be measured either directly or indirectly. In the case of a CPR course there is typically provided a mannequin that is instrumented to detect and measure at least one parameter such as forces applied by the trainee, compression depth generated by the trainee or simulated diastolic pressure that a trainee's compression would produce. These parameters can be easily measured by an instrumented mannequin, digitized and stored on an electronic medium. The invention also provides for a second remote location where training verification takes place by a verification authority. There is a third remote location where a certification authority may issue a certificate evidencing successful completion of the training or achievement of a standard.

The instrumented mannequin includes means to detect and measure physical forces applied by the trainee during practice sessions. The data may be transmitted by transmission means, such as an Internet link through a global computer network, to the verification authority's location. The verification authority's location may be able to receive, in real time, the data generated by the mannequin that would permit a professional trainer to provide oversight to the training and correct deficiencies and faulty techniques. For example, if during the training session and while the trainee is applying CPR to the mannequin, the sensors detect that there is insufficient compression in the chest to adequately generate necessary blood pressure; the system will transmit the measured data to the professional trainer located at the verification authority location for comparison to acceptable norms. The professional trainer can then indicate to the trainee that the practice session was not successful. The trainer may then require the trainee to repeat the exercise until successful.

The remote verification of training can be conducted automatically through computer means whereby feedback to the trainee is instantaneous. For example, at the end of the training session and upon completion of the practicum and theoretical examinations, the verification authority will receive the examination results, compare the examination results against acceptable values and transmit to the trainee a “pass or fail”. For example, a computer may assess the written and practical components of a training session and determine a pass or fail grade for the trainee. The calculation of a pass grade will result in the computer informing the trainee of having passed the training session. The calculation of a failed grade may result in the computer directing the trainee to repeat the training session for re-examination.

In one embodiment of the invention the remote verification authority may be empowered to issue a certificate of successful training course completion that qualified the trainee to, for example, applying CPR to a human. In another embodiment of the invention the verification authority may relay the results of the training session to a remote certification authority. The certification authority will receive a pass signal from the verification authority for a particular trainee and then issue a certificate of successful completion of the training session to that trainee with authority to practice the learned skills.

In an alternative embodiment of the invention, either the remote verification authority or the remote certification authority is able to issue the certificate immediately over a global communication system so that the trainee will receive the certificate at the trainee workstation.

In still another embodiment of the invention, and in the case of a CPR course, the entire course can be digitized and stored on a mannequin's digital storage means so that course delivery, verification and certification can take place at the location of the trainee upon successful completion of the written and practical training elements of the course.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic diagram of one embodiment of the invention.

FIG. 2 is a depiction of the trainee's location.

FIG. 3 is a depiction of a CRP mannequin.

FIG. 4 is a depiction of the verification authority.

FIG. 5 is a depiction of automated verification and certification of training.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

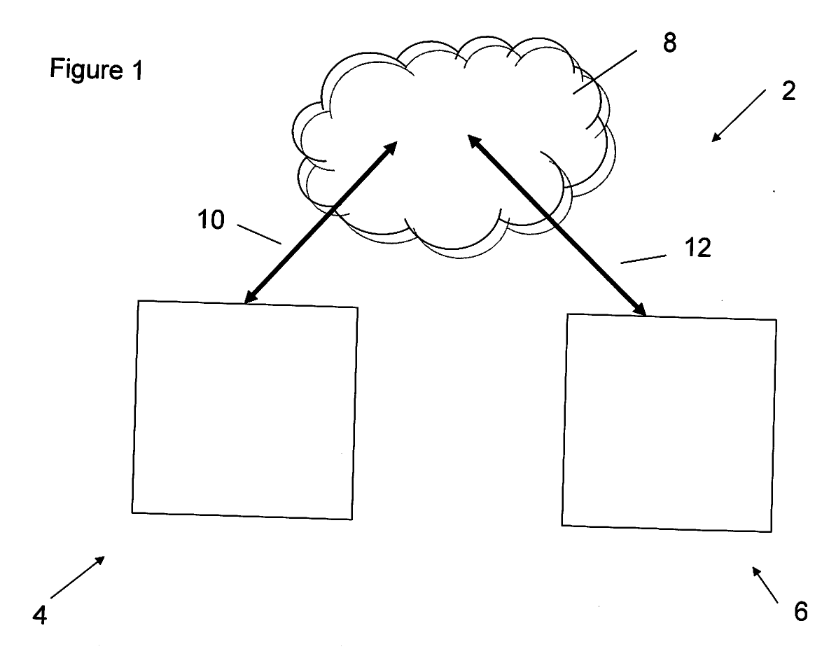

Referring to FIG. 1, there is illustrated a schematic of one embodiment of the invention which is a system 2 for the remote verification of training that requires the trainee to apply a physical or manual force to an object. One example is CPR cardiopulmonary resuscitation) or A/R (artificial respiration) training wherein the trainee has to apply compression forces to the chest of a mannequin or blow into the mouth of a mannequin with sufficient force to inflate a lung bag. There is provided a remote training location 4 which may be a remote construction site or mine or community where the training is to take place. There is provided a remote verification authority location 6 where verification of successful training will take place. There may be a remote certification authority location where a certification authority may issue certificates of successful completion of training as more fully explained below.

The training location 4 and the verification authority location 6 are in communication over a global communication network 8 by communication means 10 and 12. The verification authority location 6 may include verification authority in the guise of a professional and qualified instructor. The verification authority may also be the certification authority. Communication means are typically computer modems connected to the Internet permitting two-way audio, visual and electronic communication between the training the location, the verification authority location and the certification authority location as necessary.

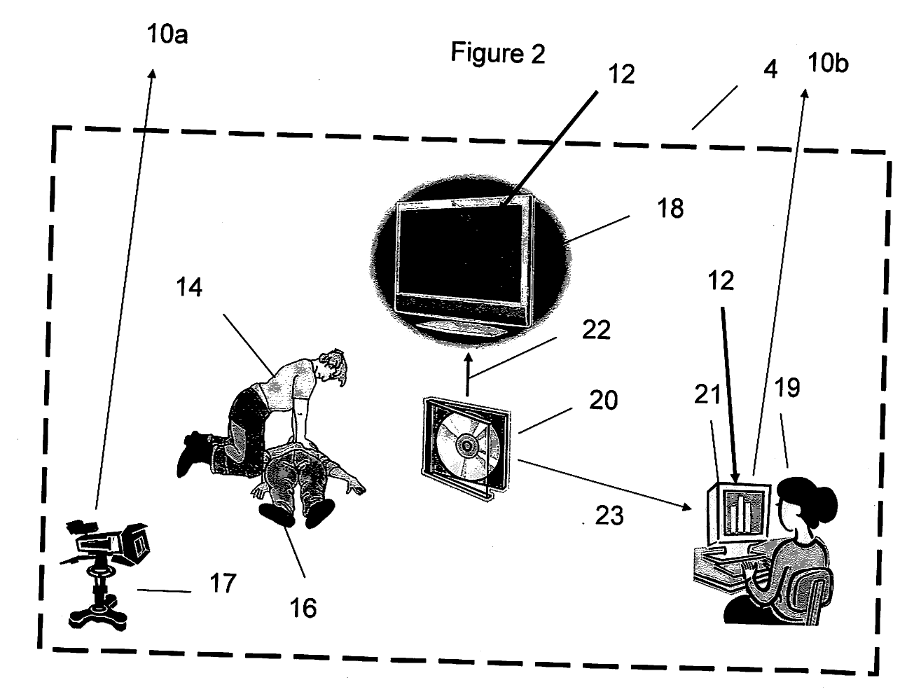

Referring to FIG. 2, there is illustrated a schematic of the remote training location 4. This remote training location 4 can be a classroom at a remote location such as a mine site having at least one trainee 14. In FIG. 2, CPR training is illustrated as it best exemplifies the system and method of the invention. However, other types of training can be used such as massage therapy or any other type of activity that requires a human to apply a physical force to another body. The training may constitute a theoretical component and a practicum. Both will be tested. FIG. 2 illustrate the trainee 14 practicing skills on a CPR mannequin 16. Since the training is being conducted remotely, the material is delivered to the remote location over the Internet 12. The material may comprise live instruction by a professional trainer transmitted from the verification authority location by way of a CCTV connection between the verification authority location and the display screen 18. In another embodiment of the invention the training session may arrive at the training location as a recorded program on a CD 20 to be played 22 on the display screen 18. In another alternative the training session can be played 23 on the computer workstation 21 for a single trainee 19. In yet another alternative of the invention the training session may be provided to trainee 19 by way of the Internet 12 directly to the workstation 21. In one embodiment of the invention the remote training location may further comprise a camera 17 to record the training session and to transmit live images 10a to the verification authority location so that a professional trainer can provide oversight to the training session and correct faults in technique as they occur.

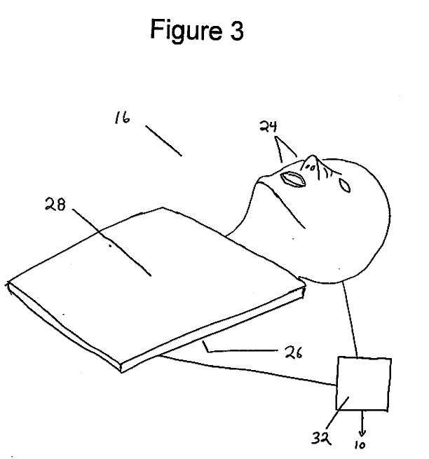

Referring to FIG. 3, and for exemplary purposes only, there is shown a view of a typical CPR mannequin 16 used in one embodiment of the invention during CPR training. Such a mannequin can be instrumented with a variety of sensors to measure a variety of physical parameters which will indicate whether the proper method of CPR or A/R is being applied during the practicum, such as:

24 Air pressure within the oral cavity during A/R;
26 Air pressure within the lung cavity during A/R;
28 Depression of the chest wall during CPR;
Pressure on the sternum during CPR;
Simulated diastolic pressure resulting from the CPR; and,
Volume of air pushed into the lung cavity during A/R.

This data can be collected and stored in digital storage means 32 for subsequent transmission 10 back to the verification authority either for real-time oversight of the practicum or for practicum assessment by way of examination.

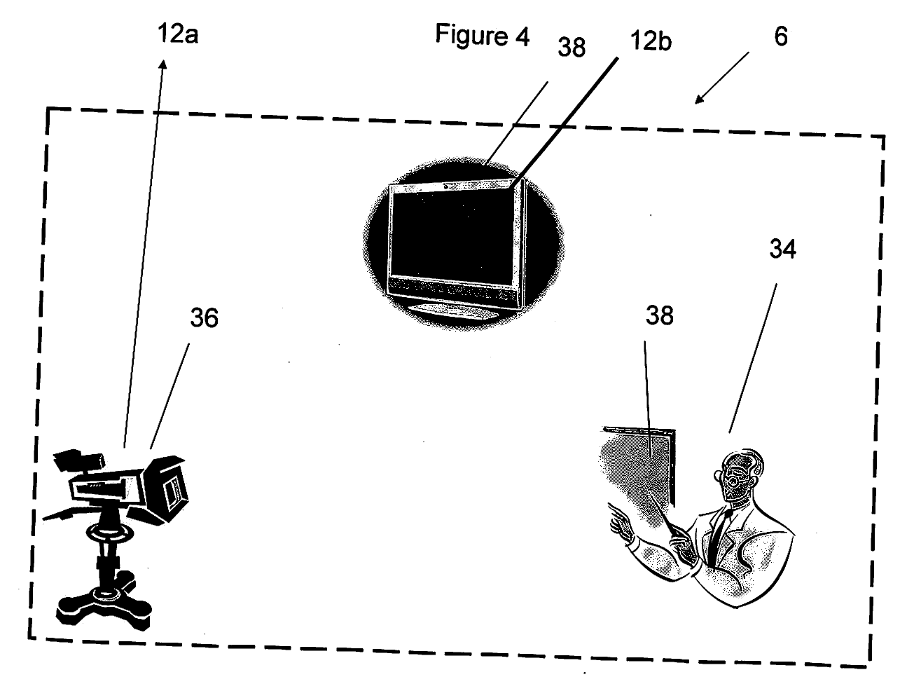

Referring now to FIG. 4 there is shown a representation of the remote location 6 where the verification authority 34 is located. This may be a community college or a hospital where the verification authority is a qualified instructor in the field being taught. There may be a camera 36 and a CCTV 38 so that the verification authority may present the instructional material live to the trainee by way of communication channel 12a and view the practicum as it occurs by way of communication channel 12b. This will permit the instructor to view the data input from the mannequin in real time while the trainee attempts CPR or A/R. If there is a problem with a particular movement, such as chest compression, the instructor can view the moves of the trainee and offer corrective advice until the mannequin indicates a proper pressure is being delivered. The camera and CCTV combination is useful in the embodiment where there is a plurality of trainees in a classroom environment. In embodiments where a single trainee 19 is present the instructor can present live to the trainee through the trainees computer workstation 21. Data from memory means 32 may also be transmitted 10 to a display consol 38 located at the instructor's workstation so that the instructor is able to see whether or not the data falls within acceptable norms.

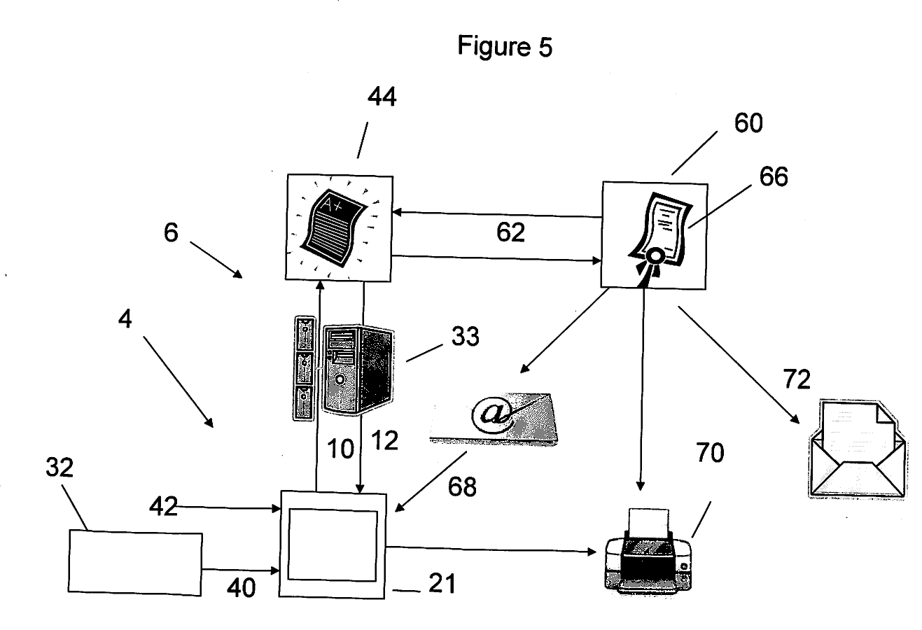

Referring to FIG. 5 and in another embodiment of the system there is no instructor at the verification authority location 6. The verification authority location 6 may comprise a server 33 in communication 12 with the remote training location 4 either through screen 18 in the case of a classroom with a plurality of trainees or through computer workstation 21 in the case of a single trainee 19. In this embodiment the server 33 will broadcast a pre-programmed training session which can be controlled at will by the trainee through the workstation 21. The trainee can be examined on the theoretical component by completing an examination on-line by inputting 42 answers into the workstation 21 and submitting 10 the results to the server 33. The trainee can be examined on the practicum by following instructions broadcast from the server 33, applying the tested movements to the mannequin, and then transmitting the results 40 from the memory storage device 32 to the server 33 through the computer workstation 21.

Since the examination answers are digitized and transmitted to the server at the verification authority location where they are marked by a computer 44, examination results may be obtained very quickly. The verification authority computer 44 generates a pass/fail signal. If a fail signal is transmitted 10 to the trainee at the workstation 21 then the trainee may be permitted to repeat the training session as often as is necessary to obtain the required skill set. If there is a pass signal generated by the verification authority computer 44 then the pass signal is sent to the certification authority 60 by communication means 62. The certification authority will then issue the certificate 66 of successful completion of the training. The certificate can be e-mailed to the trainee 68, or it can be sent to the trainee's printer 70 or it can be mailed 72 to the trainee. In situations where there is no certification authority, the verification authority can issue the certificate of successful completion to the trainee.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A system comprising:
a. a training session for training at least one trainee at a remote training location, wherein said training session comprises an examinable theoretical component and an examinable practicum comprising the application of a force on an object by the trainee, and wherein both said examinable theoretical component and said examinable practicum generate examination results for verification by;
b. a remote verification authority receiving said examination results and generating a pass/fail signal for the at least one trainee;
c. communication means for providing audio, visual and digital communication between said remote training location and said remote verification authority and between the remote verification authority and;
d. a remote certification authority for receiving said a pass signal from the verification authority and issuing a certificate of training completion to the at least one trainee.

2. The system of claim 1 wherein the remote certification authority is the remote verification authority.

3. The system of claim 1 wherein the object is a mannequin, and wherein the force is a therapeutically effective force.

4. The system of claim 1 wherein the remote training location comprises at least one computer workstation for the at least one trainee, and wherein said at least one computer workstation receives the training session from the verification authority and displays the training session to the trainee for execution.

5. The system of claim 3 wherein said mannequin is instrumented to detect and measure force values applied by the trainee thereon during said practicum.

6. The system of claim 5 wherein said force values are transmitted from the mannequin to digital storage means.

7. The system of claim 1 whereupon completion of said theoretical component, the verification authority transmits an examination to the trainee workstation for completion by the trainee, and wherein the trainee transmits examination answers to the verification authority for marking.

8. The system of claim 7 wherein upon completion of the practicum the force values are uploaded from said digital storage means to the verification authority for comparison with therapeutically acceptable values.

9. The system of claim 8 wherein the verification authority is configured to receive said examination results and the force values from the remote training location and generate a pass/fail signal.

10. The system of claim 9 wherein said pass/fail signal is transmitted to the trainee workstation.

11. The system of claim 9 wherein a pass signal is transmitted to said certification authority for issuance of a certificate of successful completion of the training session.

12. The system of claim 9 wherein a fail signal is transmitted to the trainee workstation with instructions to repeat the training session.

13. The system of claim 11 wherein said certificate is transmitted to the trainee by one of e-mail, regular mail or directly to a printer located in the remote training location.

14. The system of claim 1 wherein the remote verification authority further includes a training professional for supervision of the at least one trainee by communication means during the practicum, and wherein the at least one trainee and said training professional are in audio-visual contact during the practicum so that the training professional may provide oversight to the trainee during the practicum.

15. The system of claim 14 wherein the training professional may teach the theoretical component directly to the at least one trainee by communication means.

16. A method comprising:
a. Providing an at least one trainee for training, said at least one trainee having an at least one computer workstation at a remote training location;
b. Providing a verification authority at a remote verification authority location for transmitting a training session to said at least one trainee computer workstation for display to the at least one trainee, wherein said training session comprises a theoretical component and a practicum, and wherein said practicum comprises the application of forces by the at least one trainee on a mannequin;
c. Providing a mannequin instrumented to measure the magnitude of said application of forces by the at least one trainee;
d. Examining the at least one trainee on said theoretical component, wherein the at least one trainee generates examination answers;
e. Transmitted said examination answers to the verification authority for marking;
f. Examination the at least one trainee on said practicum and generating a dataset of force magnitudes; and,
g. Transmitting said dataset to the verification authority.

17. The method of claim 16 further comprising the marking by the verification authority of the examination answers and the comparison of the dataset to therapeutically correct force magnitudes.

18. The method of claim 17 further comprising the generation of a pass/fail signal by the verification authority.

19. The method of claim 18 wherein a pass signal is transmitted to a certification authority for generation of a certificate of successful completion of the training session.

20. The method of claim 19 wherein a fail signal is transmitted to the at least one trainee in training with instructions to repeat the training session.

21. The method of claim 19 wherein said certification authority transmits said certificate of successful completion to the at least one trainee by electronic means.
